(19) United States
(12) Patent Application Publication
(10) Pub. No.: US 2008/0285683 A1
(43) Pub. Date: Nov. 20, 2008

(54) Serial data receiving circuit

(75) Inventor: Haruki Yanbe, Kanagawa (JP)

Correspondence Address: NIXON PEABODY, LLP, 401 9TH STREET, NW, SUITE 900, WASHINGTON, DC, 20004-2128, US

(73) Assignee: OKI ELECTRIC INDUSTRY CO., LTD.

(21) Appl. No.: 11/896,521

(22) Filed: Sep. 4, 2007

(30) Foreign Application Priority Data
Oct. 26, 2006 (JP) 2006-291140

(51) Int. Cl. H04L 27/00

(52) U.S. Cl. 375/316

(57) ABSTRACT

Object: Reduction of the power consumption except during the receiving operation by analyzing the control command inputted by asynchronous method according to the CPU instructions and identifying the communication rate and the character set.

Solution: When a start instruction is received through a IF unit 23 from a CPU, a sequence control unit 22 supplies a master clock signal MCK as an internal clock signal ICK through a gate unit 11. A start-bit measuring unit 12 measures the time length of the start-bit of a first-character in the serial input data SIN, and according to the measuring results thereof, a communication rate selecting unit 13 and a receiving clock generating unit 14 generates a receiving clock signal RCK. Corresponding to the control of the sequence control unit 22, it is identified whether or not a specific command is received by receiving character strings by the first to the third character selecting units 15, 17, and 19. A character set selecting unit 21 selects a character set of asynchronous method based on the received character strings. When a halt instruction is received from the CPU or receiving is completed, the receiving clock signal RCK is halted by closing the gate unit 11.

### BACKGROUND OF THE INVENTION

1. Field of the Invention

The present invention relates to a serial data receiving circuit for receiving Data Circuit terminating Equipment (hereinafter referred to as “DCE”) command sent from Data Terminal Equipment (hereinafter referred to as “DTE”) by asynchronous method. This is a counterpart of Japanese patent application Serial Number 291140/2006, filed on Oct. 26, 2006, the subject matter of which is incorporated herein by reference.

2. Description of the Related Art

Generally, DCE such as an analog modem, or a terminal adaptor, etc. is connected by DTE of personal computer etc. using RS232C standard or the interface described in ITU-T (International Telecommunication Union-Telecommunication) recommendation V.24, and when the DTE conducts DATA communication, an alphanumeric character string is sent by asynchronous method as a DCE command for controlling the DCE connected thereto. For example, a character string of three characters “SET” or “set” is stipulated by Recommendation V.25bis as a DCE control command, and an alphanumeric combination starting with two characters “AT” or “at” called as AT command method is stipulated by Recommendation V.25bis.

In DCE, a serial data transceiver circuit referred to as Universal Asynchronous Receiver Transmitter (hereinafter referred to as “UART”) receives the DCE command transmitted by asynchronous method, and the communication control corresponding to the received DCE control command is conducted. In the above operation, the communication rate and character set in UART need to be matched to the communication rate and character set in DTE in order to DCE receives the DCE command, and various proposals for the above-mentioned matching method are proposed.

For example, according to the following patent document 1, a circuit for receiving two characters “AT” or “at” of the header part of the AT command is included in addition to the UART, and the communication rate of asynchronous method is identified by measuring the time length during when level “L” of the first starting bit is continued. Subsequently, when the start character can be received as “A” or “a” of ASCII (American Standard Code for Information Interchange) at the above identified communication rate, it is confirmed whether the following character can be received as “T” in the case where the start character is “A”, and whether the following character can be received as “t” in the case where the start character is “a”. During the above operation, when tow characters “AT” or “at” can be received, the identified communication rate and character set are set into the UART so that the UART can receive the following characters. Consequently, the CPU throughput can be reduced.

Patent document 1: Japanese Patent Specification No. 2641999.
Patent document 2: Japanese Patent Application No. 2005-219215.

### SUMMARY OF THE INVENTION

### Problem

However, since the aforementioned conventional technology is configured to correspond to only the AT command method described of consisting of alphanumeric combination starting with character string of “AT” or “at” in Recommendation V.25ter, there is a problem that the aforementioned conventional technology cannot correspond to the DCE command method described of consisting of combination of three alphabetic character string and numeric characters in Recommendation V.25bis.

In other words, in the DCE command method described of consisting of combination of a three-alphabetic-character string and numeric characters in Recommendation V.25bis, the communication condition of communication-rate and character-set used for transmitting and receiving the serial data signal is identified only by the character string of three character “SET” or “set” inputted as the DCE command, and the DCE commands of Recommendation V.25bis other than the above three character command needs to be transmitted and received using the above identified communication condition.

Consequently, the DCE commands of Recommendation V.25bis other than “SET” or “set” needs to be transmitted and received using the identified communication condition by the following processes. That is, the process of the computer processing to the universal input terminal for identifying the asynchronous-method communication rate and the character string “SET” or “set” by alternation of the digital input signal, after connecting the universal digital input terminal of the CPU for controlling the UART to the input of the UART in parallel. Furthermore, the process for setting the communication rate parameter and the character set parameter into the UART as the identified communication condition by calculating character set from the identified character string “SET” or “set”.

The object of the present invention is reduction of the CPU throughput and providing a serial data receiving circuit for reducing the power consumption, as described below. That is, the CPU throughput is reduced by analyzing the DCE command of Recommendation V.25bis consisting of a character string “SET” or “set” to identify the communication rate and character set of asynchronous method and by automatically setting the above identified communication rate and character set of asynchronous method into the UART, according to the CPU instruction. Furthermore, the power consumption can be reduced by halting the clock of the circuit for the above-mentioned process except during the receiving operation.

### Solution

According to the present invention, the serial data receiving circuit for receiving the control command consisting of the specific character string sent by the serial data of asynchronous method and identifying the communication rate and character set of the serial data is configured by the following devices.

In other words, the above serial data receiving circuit is characterized by including an interface device for accepting a start instruction from the outside, a receiving device for receiving a serial input signal inputted by asynchronous method when the above start instruction is provided, a measuring device for measuring the time length of the start bit of the first character of the above serial input signal, a communication rate selecting device for selecting the corresponding communication rate to the above measured start bit time out of the given plural of corresponding communication rates, an identifying device for receiving a character string of the above serial input signal according to the above selected communication rate and identifying whether the above received character string corresponds to the aforementioned specific character string.

Furthermore, the above serial data receiving circuit is characterized by including a character set selecting device for selecting the above character set of asynchronous method based on the above received character string when the character string is identified to be matched by the above identifying device, and is characterized by the configuration for halting the receiving clock signal for receiving the above serial input signal when the above start instruction has not been ordered, the above halt instruction is ordered from the outside, and the above character string receiving is completed.

### EFFECTS OF THE PRESENT INVENTION

The serial data receiving circuit of the present invention is configured to start measuring the start bit time of the first character of serial input signal according to the start instruction from the outside, select the communication rate based on the above measuring result, identify whether the character string received at the above selected communication rate corresponds to the specific character string, and select the above character set of asynchronous method in the case of identifying that the above character string corresponds to the above specific character string. Furthermore, the above serial data receiving circuit is configured to halt the receiving clock in the case where the halt instruction is ordered from the outside, or the character string receiving is completed. Consequently, there are effects that the CPU throughput can be reduced and the power consumption can be reduced except during the receiving operation.

### BRIEF DESCRIPTION OF THE DRAWINGS

FIG. 1: A configuration diagram of a serial data receiving circuit according to the first embodiment of the present invention.

FIG. 2: A flowchart showing a receiving procedure of the DCE command in the serial data receiving circuit of FIG. 1.

FIG. 3: A timing chart showing the operation of the first character receiving unit 15.

FIG. 4: A timing chart showing the operation of the second character receiving unit 17.

FIG. 5: A timing chart showing the operation of the third character receiving unit 19.

FIG. 6: A diagram showing the correspondence between start-bit counting values and communication rates.

FIG. 7: A diagram showing the correspondence between receiving character strings and character sets.

FIG. 8: A configuration diagram of a serial data receiving circuit according to the second embodiment of the present invention.

FIG. 9: A flowchart showing a receiving procedure of the DCE command in the serial data receiving circuit of FIG. 8.

### DETAILED DESCRIPTION OF THE PREFERRED EMBODIMENTS

The above mentioned and other objectives of the present invention, and the novelty of the present invention will become clear more thoroughly by reading the following description of the preferred embodiment referring to the drawings. However, the drawings are only for the explanation, and do not limit the scope of the present invention.

### First Embodiment

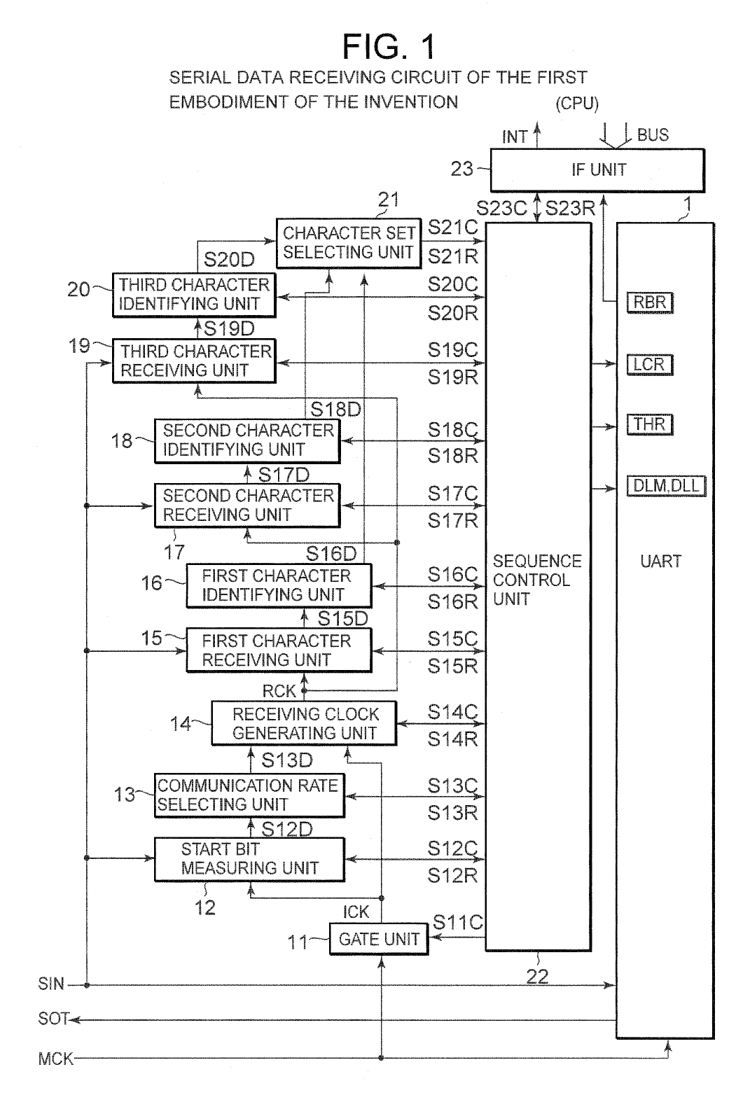

FIG. 1 is a configuration diagram of a serial data receiving circuit according to the first embodiment of the invention. The serial data receiving circuit receives a DCE control command sent from a DTE to a DCE by asynchronous method, and includes a detecting circuit for detecting receiving of the DCE control command, in addition to a conventional UART 1.

The UART 1 is a circuit for converting a serial input signal SIN of asynchronous method to a parallel data, and a register RBR (Receiver Buffer Register) for holding a receiving data, a register LCR (Line Control Register) for setting a character set, a register DLM (Divisor Latch: MS) for setting a communication rate, a DLL (Divisor Latch: LS), and a register THR (Transmitter Holding Register).

Meanwhile, the detecting circuit consists of a gate unit 11, a start bit measuring unit 12, a communication rate selecting unit 13, receiving clock generating unit 14, a first character receiving unit 15, a first character identifying unit 16, a second character receiving unit 17, a second character identifying unit 18, a third character receiving unit 19, a third character identifying unit 20, a character set selecting unit 21, a sequence control unit 22, and an interface unit (hereinafter referred to as “IF unit”) 23.

The gate 11 controls an output of a master clock signal MCK according to the control from the sequence control unit 22, and provides the start bit measuring unit 12 and the receiving clock generating unit 14 with an internal clock signal ICK.

The start bit measuring unit 12 measures a bit width of the start bit given as a serial input signal SIN according to the control from the sequence control unit 22. That is, at the time point when a change from level “H” to level “L” of the serial input signal SIN is detected, the counting of the internal clock signal ICK given from the gate unit 11 is started, and at the time point when a change from level “L” to level “H” of the above serial input signal SIN is detected, the above counting is halted to output a data S12D of the above counting result to the communication rate selecting unit 13.

The communication rate selecting unit 13 selects a corresponding communication rate out of the pre-determined communication rates of asynchronous method, based on the data S12D form the start bit measuring unit 12, according to the control from the sequence control unit 22, and the communication rate selecting unit 13 provides the receiving clock generating unit 14 with a data S13D of the selected receiving-clock set-value. Furthermore, the communication rate selecting unit 13 notifies the sequence control unit 22 of an information of the selected communication rate.

The receiving clock generating unit 14 generates the receiving clock signal RCK 16 times as fast as the corresponding communication rate from the internal clock signal ICK, based on a data S13D from the communication rate selecting unit 13, according to the control from the sequence control unit 22. The receiving clock signal RCK is provided the first character receiving unit 15, the second character receiving unit 17, and the third character receiving unit 19.

The first character receiving unit 15 acquires a first character by reading the serial input signal SIN, based on the receiving clock signal RCK, according to the control from the sequence unit 22. That is, the first character receiving unit 15 reads out the serial input signal SIN at the eighth clock timing in the 16 clock unit of the receiving clock signal RCK and acquires the first character consisting of eight bits of bit 0-7 by repeating the above operation eight times. Furthermore, the first character receiving is fixed at the time point when the stop bit is confirmed at the eighth clock timing of the receiving clock signal RCK. Subsequently, the first character receiving unit 15 provides the first character identifying unit 16 with the fixed first character as a data S15D.

The first character identifying unit 16 identifies whether the data S15D from the first character receiving unit 15 is “S” of ASCII (that is, hexadecimal, 53 or D3), or “s” of ASCII (that is, hexadecinmal, 73 or F3), or not, according to the control from the sequence control unit 22. The first character identifying unit 16 notifies the character set selecting unit 21 of a data S16D of the above identifying result.

The second character receiving unit 17 acquires a second character by reading the serial input signal SIN, based on the receiving clock signal RCK, according to the control from the sequence unit 22. That is, when the second character receiving unit 17 is instructed to start receiving the second character, the second character receiving unit 17 reads out the serial input signal SIN at the eighth clock timing out of the 16 clock unit of the receiving clock signal RCK after 16 clock blanking thereof, and acquires the second character consisting of eight bits of bit 0-7 by repeating the above operation eight times. Furthermore, the second character receiving unit 17 provides the second character identifying unit 18 with the second character as a data S17D, at the time point when the stop bit is acquired at the eighth clock timing of the receiving clock signal RCK.

The second character identifying unit 18 identifies whether the data S17D from the second character receiving unit 17 corresponds to any of “S” of ASCII (hexadecimal, 53 or D3), “s” (hexadecinmal, 73 or F3), “E” of ASCII (hexadecimal, 45 or C5), and “e” of ASCII (hexadecimal, 65 or E5), or not, according to the control from the sequence control unit 22. The second character identifying unit 18 notifies the character set selecting unit 21 of a data S18D of the above identifying result.

The third character receiving unit 19 acquires a third character by reading the serial input signal SIN, based on the receiving clock signal RCK, according to the control from the sequence unit 22. That is, when the third character receiving unit 19 is instructed to start receiving the third character, the third character receiving unit 19 reads out the serial input signal SIN at the eighth clock timing in the 16 clock units of the receiving clock signal RCK after 16 clock blanking thereof, and acquires the third character consisting of eight bits of bit 0-7 by repeating the above operation eight times. Furthermore, the third character receiving unit 19 provides the third character identifying unit 20 with the third character as a data S19D, at the time point when the stop bit is acquired at the eighth clock timing of the receiving clock signal RCK.

The third character identifying unit 20 identifies whether the data S19D from the third character receiving unit 19 corresponds to “T” of ASCII (hexadecimal, 54 or D4), or “t” (hexadecinmal, 74 or F4), or not, according to the control from the sequence control unit 22. The third character identifying unit 20 notifies the character set selecting unit 21 of a data S20D of the above identifying result.

The character set selecting 21 selects the pre-determined character set, based on the data S16D from the first character identifying unit 16, the data S18D from the second character identifying unit 18, and the data S20D from the third character identifying unit 20, to notify the sequence control unit 22 of the above selected character set. The above-mentioned character set means a combination of a number of data bit (7 or 8), a parity form (even. odd, or no parity), a number of stop bit (1 or 2).

The sequence control unit 22 controls sequentially operations of each block of the gate units 11 to the character set selecting unit 21, based on the control command from the external CPU trough the IF unit 23, and simultaneously sets various types of registers, LCR, THR, DLM, and DLL in the UART 1.

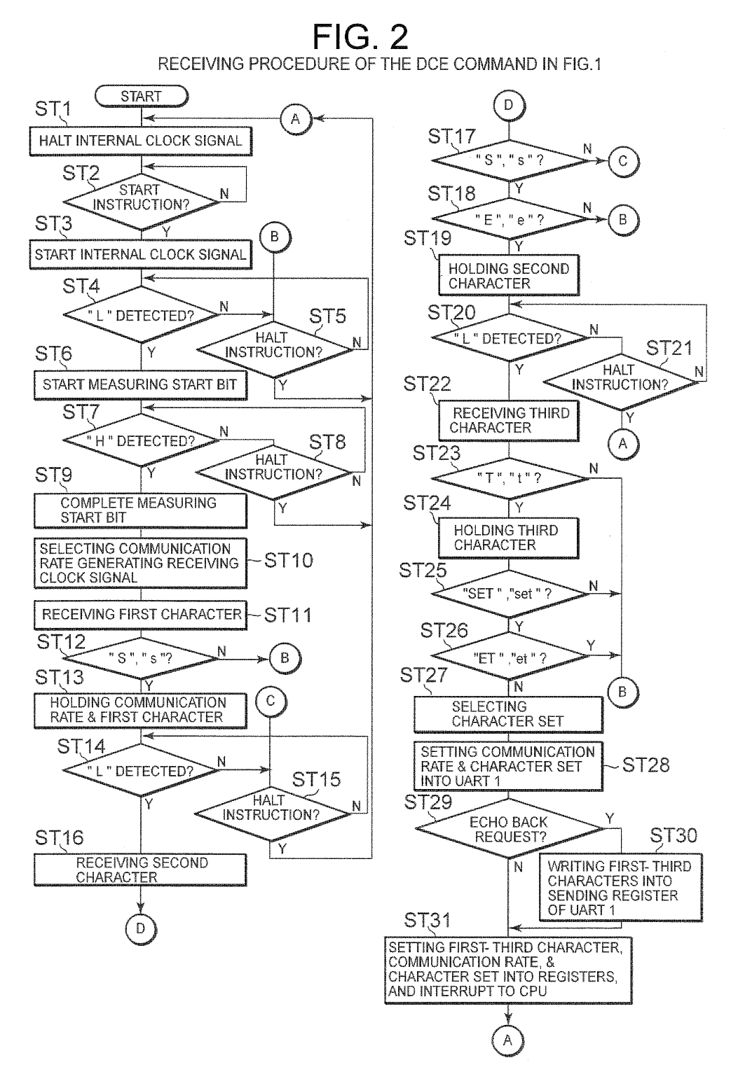

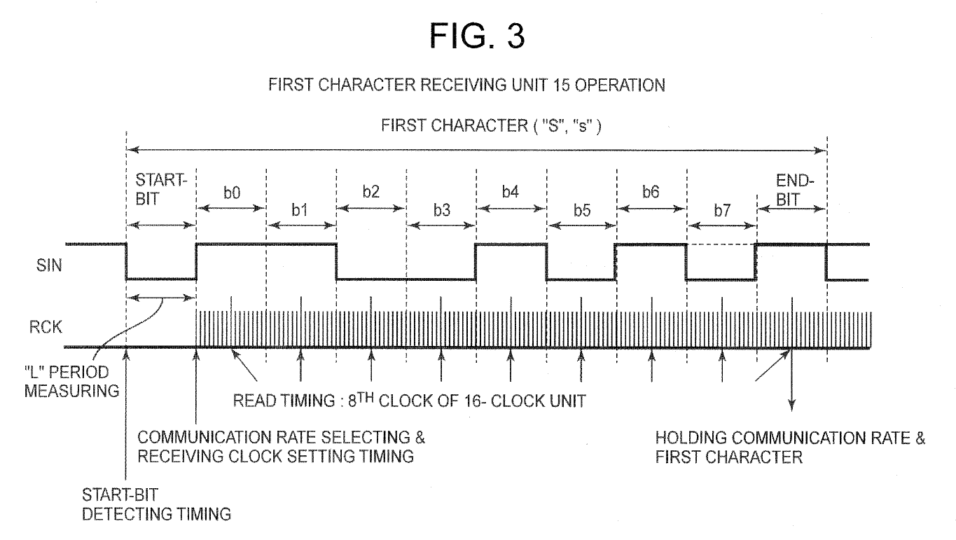

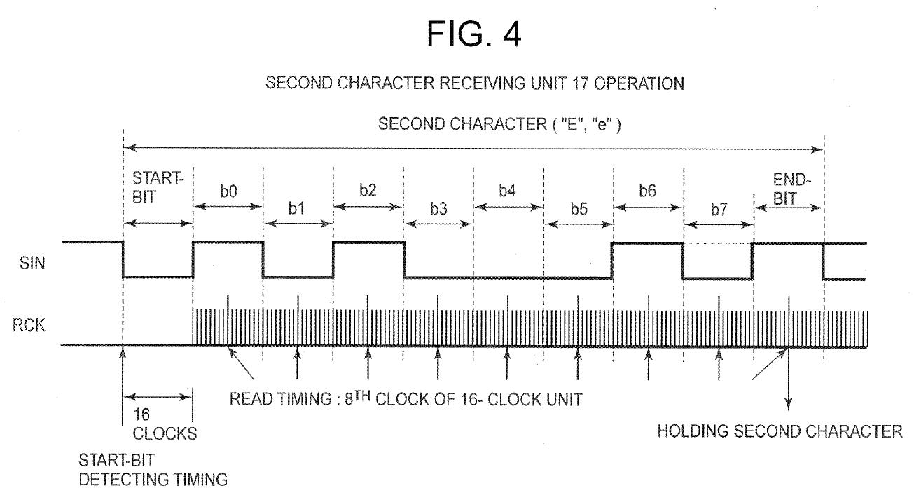

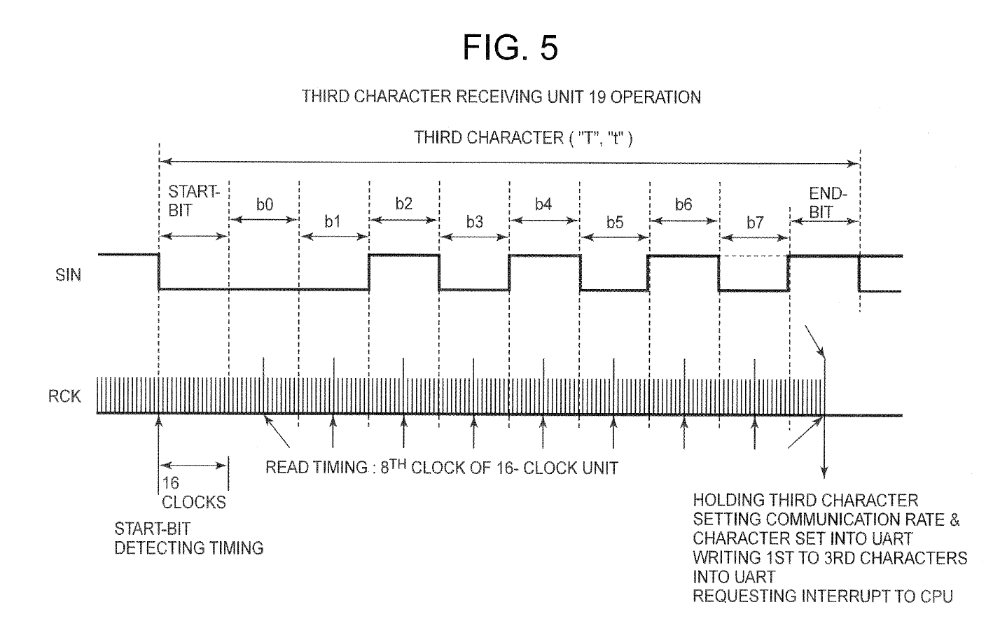

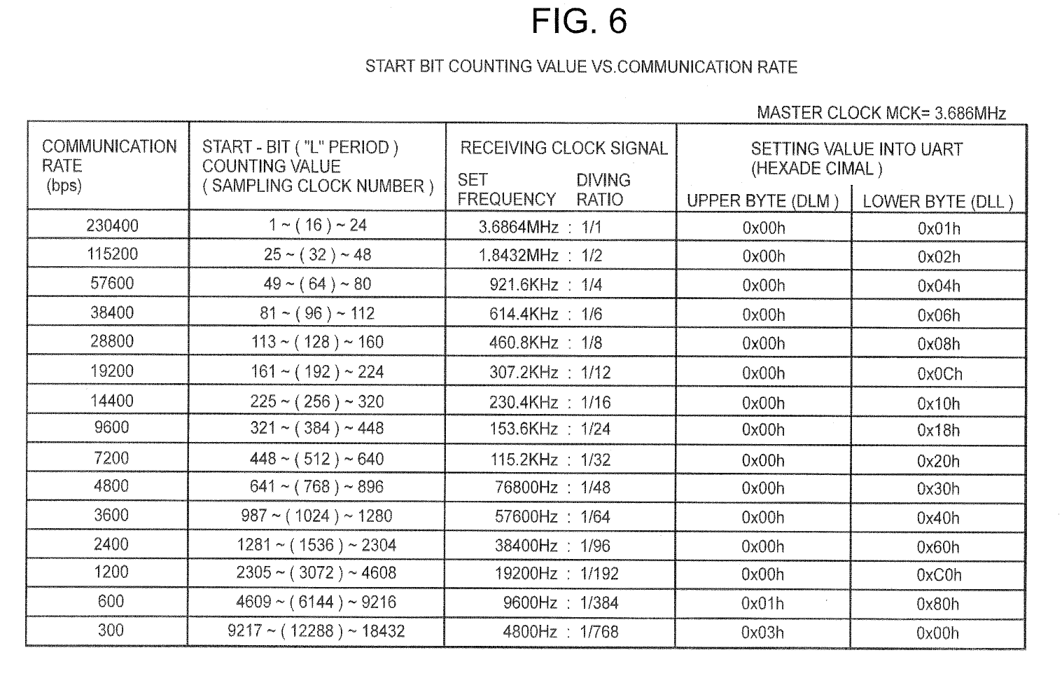

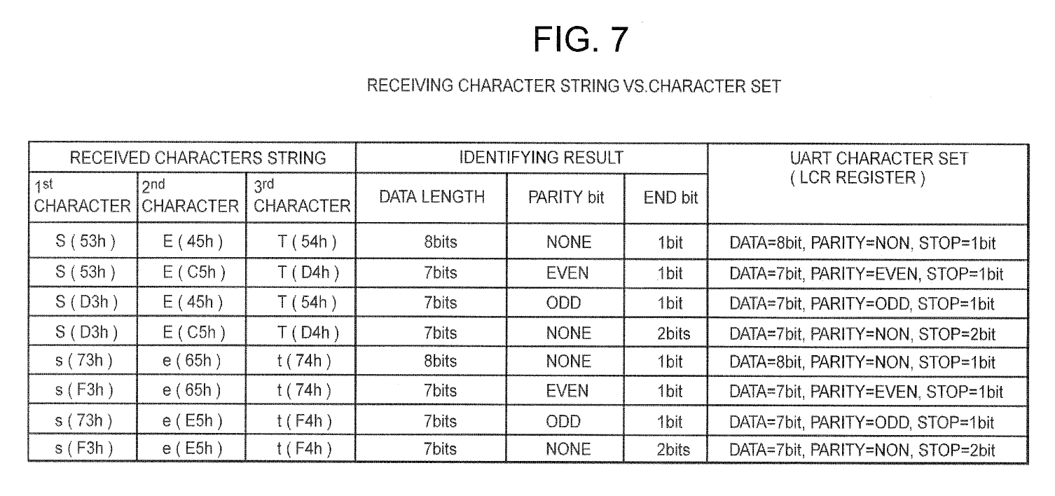

FIG. 2 is a flowchart showing the receiving procedure of the DCE command in the serial data receiving circuit of FIG. 1. And, FIG. 3, FIG. 4, and FIG. 5 are timing charts showing operations of the first character receiving unit 15, the second character receiving unit 17, and third character receiving unit 19, respectively. Furthermore, FIG. 6 is a diagram showing a correspondence between the counting values of the start bit measured by the start bit measuring unit 12 and the communication rate selected by the communication rate selecting unit 13. FIG. 7 is a diagram showing a correspondence between the receiving character strings of the first character to the third character and the character set being set by the character set selecting unit 21. The operation of FIG. 1 will be explained, referring to the above FIG. 2-7, as below.

First, the whole general operation will be explained. When a start instruction is given from a CPU not shown in the drawings through the IF unit 23, a process to the DCE command being sent from the DCE by asynchronous method based on Recommendation V.25bis is processed. Consequently, the internal clock ICK starts being supplied and simultaneously a receiving process of the first character starts.

In the first character receiving process, the corresponding communication rate is selected by measuring a communication rate based on measuring the period of “L” of the start bit of the first character, and simultaneously, eight bits corresponding to the first character is received. In the case where the first character corresponds to “S” or “s”, the process is proceeded to the second character receiving process after holding the above first character. In the case where the first character does not correspond to “S” or “s”, the process for receiving the first character is processed again.

In the second character receiving process, detecting location of the start bit and receiving eight bits of the second character are processed, and in the case where the second character corresponds to “E” or “e”, the process for receiving the third character is processed after holding the above second character. In the case where the second character corresponds to “S” or “s”, the process for receiving the second character is processed. Meanwhile, in the case where the above second character does not match to any of “S”, “s”, “E”, or “e”, the process for receiving the first character is processed again.

In the third character receiving process, detecting location of the start bit location and receiving eight bits of the third character are processed, and in the case where received third character corresponds to “T” or “t”, the combination confirmation process is processed after holding the above third character. In the case where the above second character does not match to “T”, or “t”, the process for receiving the first character is processed again.

In the combination confirmation process, in the case where the character string of the first to the third characters corresponds to “SET” or “set”, and the combination of “ET” or “et” of two characters consisting of the second and the third character does not match to any of hexadecimal 45 and D4, hexadecimal C5 and 54, hexadecimal 65 and F4, or hexadecimal E5 and 74, the process for selecting the character set is processed again. In the case where the character string of the first to the third character does not match to “SET” or “set”, or the combination of “ET” or “et” of two characters consisting of the second and the third character corresponds to hexadecimal 45 and D4, hexadecimal C5 and 54, hexadecimal 65 and F4, or hexadecimal E5 and 74, the process for receiving the first character is processed again.

In the character set selecting process, the character set is selected from “SET” or “set” of the combination of the character string, the communication rate is set to the communication rate setting registers DLM, DLL of the UART 1, and simultaneously, the above selected character set is set to the character-set setting register LCR of the above UART 1. Furthermore, in the case of an echo-back request from the CPU, the first to the third characters held are written to the receiving register THR of the UART 1.

Finally, the selected character set, the held communication rate, and the held first to third characters are set in the register of the IF unit 23, and an interrupt request for notification of completion is sent to the CPU. Subsequently, the internal clock ICK is halted, and the next instruction from the CPU is being waited. By the above operation, the internal clock is being supplied during period from the start instruction to the interrupt request for notification of completion.

The operation of each of configuration blocks will be explained in details as below. The sequence control unit 22 processes the internal clock halting process as an initial setting process (step ST1). That is, after the sequence control unit 22 halts the internal clock ICK to the gate unit 11 by giving the gate control signal S11C, the sequence control unit 22 becomes in the state of waiting the start instruction from the CPU. The sequence control unit 22 is waiting for the start instruction for detecting “SET” from the CPU given by a CPU bus signal BUS and the IF unit 23 (step ST2).

When the sequence control unit 22 receives an operation control signal S23R from the IF unit 23 as a start instruction for detecting “SET” from the CPU, the sequence control unit 22 outputs a gate control signal S11C to the gate unit 11, and starts supplying the internal clock ICK the same as the master clock MCK being provided the UART 1. Consequently, the sequence control unit 22 becomes in the state of being started to supply the internal clock. Furthermore, sequence control unit 22 outputs a start-bit-period measuring control signal S12C to the start bit measuring unit 12, and starts detecting “L” of the start bit in the serial input signal SIN using the internal clock signal ICK. Therefore, sequence control unit 22 becomes in a detecting process of the start bit “L” (step ST4), and sequence control unit 22 is waiting for a start-bit-period measuring control signal S11R from the start bit measuring unit 12 as a notification of detecting “L”.

The sequence control unit 22 is processing a confirming process of the halt instruction from the CPU (step ST5) during the detecting process of the start bit “L” (step ST4). In the case where the sequence control unit 22 receives the halt instruction of detecting “SET” of an operation control signal S23R from the CPU given by the CPU bus signal BUS and the IF unit 23, the sequence control unit 22 outputs the start-bit-period measuring control signal S12C for halting detecting the start bit of “L” to the start bit measuring unit 12. Consequently, the sequence control unit 22 returns to the initial state of the internal-clock halting process, and becomes in the state of waiting the start instruction to wait for the start instruction of detecting “SET” from the CPU after halting supplying the internal clock signal ICK to the gate unit 11 by the gate control signal S11C.

When the start-bit measuring unit 12 detects that the serial input signal SIN changes from “H” to “L”, the start-bit measuring unit 12 notifies the sequence control unit 22 of detecting “L” by the start-bit-period measuring control signal S12R, and starts counting the internal clock ICK. The sequence control unit 22 processes a measuring start process of the start-bit period (step ST6) and instructs the start bit measuring unit 12 to start detecting of “H” of the start bit in the serial input signal SIN by the start-bit period measuring control signal S12C, when receiving the notification of detecting “L” from the start-bit measuring unit 12. Subsequently, the sequence control unit 22 becomes in a state of detecting process of “H” of the start bit (step ST7), and waits for a notification of detecting “H” of the start bit by the start-bit period measuring control signal S12R from the start-bit measuring unit 12.

The sequence control unit 22 processes a confirming process of the halt instruction from the CPU (step ST8) during a detecting process of the start bit “H” (step ST7). In the case where the sequence control unit 22 receives the halt instruction of detecting “SET” by an operation control signal S23R given by the CPU bus signal BUS from the CPU and the IF unit 23, the sequence control unit 22 outputs the start-bit-period measuring control signal S12C to the start bit measuring unit 12, halts detecting the start bit of “H”, and returns to the internal-clock halting process (ST1). Furthermore, the sequence control unit 22 is waiting for the start instruction of detecting “SET” from the CPU after halting supplying the internal clock signal ICK to the gate unit 11 by the gate control signal S11C.

The start-bit measuring unit 12 counts the internal clock signal ICK until the serial input signal SIN changes from “L” to “H”. When the start-bit measuring unit 12 detects that the serial input signal SIN changes from “L” to “H”, the start-bit measuring unit 12 halts counting the internal clock ICK and sends the above counting values thereof to the communication-rate selecting unit 13 as the data S12D. At the same time, the start-bit measuring unit 12 outputs the start-bit-period measuring control signal S12R to the sequence control unit 22 and notifies of detecting “H”.

When the sequence control unit 22 receives the notification of detecting “H” from the start bit measuring unit 12, the sequence control unit 22 processes an halting process of measuring the start-bit period (step ST9), instructs the communication rate selecting unit 13 to select the communication rate by a communication rate selecting control signal S13C, and waits for the notification of the communication rate to the registers DLM, DLL of the UART 1 by the communication rate selecting control signal S13R from the above communication rate selecting unit 13.

When the selected communication rate is notified to the communication selecting unit 13 by the communication rate selecting signal S13C from the sequence control unit 22, the communication selecting unit 13 selects the corresponding communication rate out of the pre-determined communication rates referring the table shown in FIG. 6. Subsequently, the communication rate selecting unit 13 sends the selected set value of receiving clock as the data S13D to the receiving clock generating unit 14 and notifies the sequence control unit 22 of the set value of communication rate for the registers DLM, DLL of the UART 1 by the communication rate selecting control signal S13R.

When the sequence control unit 22 receives the selected set-value of communication rate for the registers DLM, DLL of the UART 1 by the communication rate selecting control signal S13R from the communication rate selecting unit 13, the sequence control unit 22 processes a selecting process of the communication rate (step ST10). The sequence control unit 22 instructs the receiving clock generating unit 14 to generate a receiving clock RCK by a receiving clock generating signal S14C, and waits for a notification of starting to generate the receiving clock RCK by a receiving clock generating signal S14R.

When the receiving clock generating unit 14 is instructed to generate the receiving clock RCK by the receiving clock generating signal S14C from the sequence control unit 22, the receiving clock generating unit 14 generates the receiving clock RCK 16 times as fast as the corresponding communication rate from the internal clock signal ICK according to the set-value of receiving clock sent as the data S13D, and notifies simultaneously the sequence control unit 22 of starting to generate the receiving clock RCK by the receiving clock generating signal S14R.

When the sequence control unit 22 receives a notification of starting to generate the receiving clock RCK by the receiving clock generating signal S14R from the receiving clock generating unit 14, the sequence control unit 22 instructs the first character receiving unit 15 to start receiving the first character by the first character receiving control signal S15C. Subsequently, the sequence control unit 22 waits for a notification of the first character and receiving completion of the first character by a first character receiving control signal S15R from the first character receiving unit 15.

When the first character receiving unit 15 is instructed to start receiving the first character by the first receiving control signal S15C from the sequence control unit 22, as shown in FIG. 3, the first character receiving unit 15 acquires the eight-bit first character of bits 0-7 by reading out the serial input signal SIN at the timing of the eighth clock out of 16 clock unit of the receiving clock RCK and repeating the above operation eight times. Furthermore, at the time point when the first character receiving unit 15 confirms the end bit at the timing of the eighth clock of the receiving clock RCK, the first character receiving unit 15 notifies the first character identifying unit 16 of the received first character as the first character receiving control signal S15D, and notifies simultaneously the sequence control unit 22 of the first character and receiving completion of the first character by the first character receiving control signal S15R.

When the sequence control unit 22 receives notification of the first character and receiving completion of the first character by the first character receiving control signal S15R from the first character receiving unit 15, the sequence control unit 22 processes a first character receiving process (step ST11). The sequence control unit 22 instructs the first character identifying unit 16 to identify the first character by a first character identifying control signal S16C, and waits for an identifying result of the first character by a first character identifying control signal S16R from the first character identifying unit 16.

When the first character identifying unit 16 is instructed to identify the first character by the first character identifying control signal S16C from the sequence control unit 22, the first character identifying unit 16 notifies the sequence control unit 22 of the identifying result by the first character identifying control signal S16R and sends simultaneously the above identifying result as the data S16D to the sequence control unit 22 after identifying whether the first received character received from the first character receiving unit 15 as the data S15D corresponds to “S” or “s”, or not.

When the sequence control unit 22 receives the identifying result by the first character identifying control signal S16C from the first received character identifying unit 16, the sequence control unit 22 processes a first character identifying process (step ST12). In the case where the first character corresponds to “S” or “s” according to the above identifying result, the sequence control unit 22 processes a holding process (step ST13) of the communication rate and the first character in order to hold the above communication rate for being set into the registers DLM, DLL of the UART 1 received by the communication rate selecting control signal S13C from the communication rate selecting unit 13 and hold the first character received by the first character receiving control signal S15R. The sequence control unit 22 instructs the second character receiving unit 17 to start detecting “L” of the start bit by the second character receiving control signal S17C to become in the state of detecting “L” of the start bit, and waits for a notification of detecting “L” by a second character receiving control signal S17R from the second character receiving unit 17.

In the case where the first character corresponds to “others” according to the identifying result of the furst character received from the first character received identifying unit 16 in the first character identifying process (step ST12), the sequence control unit 22 instructs the start bit measuring unit 12 to start detecting “L” of the start bit by the start-bit period measuring control signal S12C, and at the same time, returns to the confirming process of the halt instruction of detecting “SET” of the start bit (step ST5). The sequence control unit 22 becomes in the sate of detecting “L” of the start bit (step ST4), and waits for a notification of detecting “L” by the start-bit period measuring control signal S12R from the start-bit measuring unit 12.

During the process for detecting “L” of the start bit (step ST4), the sequence control unit 22 processes a confirming process of the halt instruction of detecting “SET” from the CPU (step ST15). In the case of receiving the halt instruction of detecting “SET” of the operation control signal S23R given by the CPU bus signal BUS and the IF unit 23, the sequence control unit 22 instructs the second character receiving unit 17 to halt detecting “L” of the start bit by the second character receiving control S17C. And then, the sequence control unit 22 processes the internal clock halt process (step ST1) to instruct the gate unit 11 to halt outputting the internal clock ICK by the gate control signal S11C. Subsequently, the sequence control unit 22 becomes the waiting state of the start instruction from the CPU (step ST2) and waits for the start instruction of detecting “SET” from the CPU.

When the second character receiving unit 17 detects that the serial input signal SIN changes from “H” to “L”, the second character receiving unit 17 notifies the sequence control unit 22 of detecting “L” by the second character receiving control signal S17R, and simultaneously acquires the eight-bit second character of bits 0-7 by reading out the serial input signal SIN at the timing of the eighth clock out of 16 clock unit of the receiving clock RCK after 16 clock blanking of the receiving clock RCK and repeating the above operation eight times, as shown in FIG. 4. Furthermore, at the time point when the second character receiving unit 17 confirms the end bit at the timing of the eighth clock out of 16 clock of the receiving clock RCK, the second character receiving unit 17 notifies the second character identifying unit 18 of the received second character as the data S17D, and notifies simultaneously the sequence control unit 22 of the second character and the receiving completion of the above second character by the second character receiving control signal S17R.

When the sequence control unit 22 receives notification of the second character and receiving completion of the send character by the second character receiving control signal S17R from the second character receiving unit 17, the sequence control unit 22 processes a second character receiving process (step ST16). The sequence control unit 22 instructs the second character identifying unit 18 to identify the second character by a second character identifying control signal S18C, and waits for an identifying result of the second character by a second character identifying control signal S18R from the second character identifying unit 18.

When the second character identifying unit 18 is instructed to identify the second character by the second character identifying control signal S18C from the sequence control unit 22, the second character identifying unit 18 notifies the sequence control unit 22 of the identifying result by the second character identifying control signal S18R and notifies simultaneously the character set selecting unit 21 of the above identifying result as the data S18D after identifying whether the second received two characters from the second character receiving unit 17 as the data S17D correspond to “S”, “s” or “E”, “e”, or not.

When the sequence control unit 22 receives the identifying result by the second character identifying control signal S18R from the second character identifying unit 18, the sequence control unit 22 processes a second character identifying process (step ST17). In the case where the second character does not correspond to “S” or “s” according to the above identifying result received from the second character identifying unit 18, the sequence control unit 22 processes a second character identifying process (step ST18). In the case where the second character corresponds to “S” or “s”, the sequence control unit 22 instructs the second character receiving unit 17 to start detecting of “L” of the start bit by the second character receiving control signal S17C, returns simultaneously to the confirming process of the halt instruction of detecting “SET” (step ST15), becomes in the state of detecting “L” of the start bit, and waits for a notification of detecting “L” by a second character receiving control signal S17R from the second character receiving unit 17.

In the case where the second character corresponds to “E” or “e” according to the identifying result received from the second character identifying unit 18 in the identifying process of the second character (step ST18), the sequence control unit 22 hold the second character received by the second character receiving control signal S17R from the second character receiving unit 17, and processes the holding-state process of the second character (step ST19). The sequence control unit 22 instructs the third character receiving unit 19 to start detecting of “L” of the start bit by the third character receiving control signal S19C, processes a receiving process of the third character (step ST20), and waits for a notification of detecting “L” by a third character receiving control signal S19R from the third character receiving unit 19.

In the case where the second character corresponds to “others” according to the identifying result of the second character received from the second character received identifying unit 18 in the second character identifying process (step ST18), the sequence control unit 22 instructs the start bit measuring unit 12 to start detecting of “L” of the start bit by the start-bit period measuring control signal S12C, and at the same time, returns to the confirming process of the halt instruction of detecting “SET” of the start bit (step ST5). Consequently, the sequence control unit 22 becomes in the sate of detecting “L” of the start bit (step ST4), and waits for a notification of detecting “L” by the start-bit period measuring control signal S12R from the start-bit measuring unit 12.

In the state of detecting “L” of the start bit (step ST20), the sequence control unit 22 processes a confirming process of the halt instruction of detecting “SET” from the CPU (step ST21). In the case of receiving the halt instruction of detecting “SET” from the CPU by the operation control signal S23R given by the CPU bus signal BUS and the IF unit 23, the sequence control unit 22 instructs the third character receiving unit 19 to halt detecting “L” of the start bit by the third character receiving control S19C. Consequently, after the sequence control unit 22 returns to the initial state of the internal clock halting state (step ST1) to instruct the gate unit 11 to halt outputting the internal clock ICK by the gate control signal S11C, the sequence control unit 22 becomes in the waiting state for start instruction (step ST2) to wait for the start instruction of detecting “SET” from the CPU.

When the third character receiving unit 19 detects that the serial input signal SIN changes from “H” to “L”, the third character receiving unit 19 notifies the sequence control unit 22 of detecting “L” by the third character receiving control signal S19R, and simultaneously acquires the eight-bit third character of bits 0-7 by reading out the serial input signal SIN at the timing of the eighth clock out of 16 clock unit of the receiving clock RCK after 16 clock blanking of the receiving clock RCK and repeating the above operation eight times, as shown in FIG. 5. Furthermore, at the time point when the third character receiving unit 19 confirms the end bit at the timing of the eighth clock of the receiving clock RCK, the third character receiving unit 19 notifies the third character identifying unit 20 of the received third character as the data S19D, and notifies simultaneously the sequence control unit 22 of the third character and the receiving completion of the third character by the third character receiving control signal S19R.

When the sequence control unit 22 receives notification of the third character and receiving completion of the third character by the third character receiving control signal S19R from the third character receiving unit 19, the sequence control unit 22 instructs the receiving clock generating unit 14 to halt the receiving clock RCK by the clock generating control signal S14C, and then the receiving clock generating unit 14 halts the receiving clock RCK. At the same time, the sequence control unit 22 instructs the third character identifying unit 20 to identify the third character by a third character identifying control signal S20C, and waits for an identifying result of the third character by the third character identifying control signal S20C from the above third character identifying unit 20.

When the third character identifying unit 20 is instructed to identify the third character by the third character identifying control signal S20C from the sequence control unit 22, the third character identifying unit 20 notifies the sequence control unit 22 of the identifying result by the third character identifying control signal S20R and sends simultaneously the above identifying result as the data S20D to the character selecting unit 21 as well after identifying whether the third characters received from the third character receiving unit 19 as the data S19D correspond to “T”, “t”, or “others” that is “not-matching” case. When the sequence control unit 22 receives the identifying result of the third character by the third character identifying control signal S20R from the third character identifying unit 20, the sequence control unit 22 processes an identifying process of the third character (step ST23). In the case where the third character corresponds to “T” or “t” according to the identifying result of the third character received from the third character identifying unit 20, the sequence control unit 22 becomes in a holding state of the third character (step ST24) to hold the third character received by the third character receiving control signal S20R from the third character identifying unit 20, and proceeds to a process for identifying the combination (step ST25).

In the case where the third character corresponds to “others” according to the identifying result of the third character received from the third character identifying unit 20 in the third character identifying process (step ST23), the sequence control unit 22 instructs the start bit measuring unit 12 to start detecting of “L” of the start bit by the start-bit period measuring control signal S12C, and at the same time, returns to the process for confirming the halt instruction of detecting “SET” of the start bit (step ST5). Consequently, the sequence control unit 22 becomes in the sate of detecting “L” of the start bit (step ST4), and waits for a notification of detecting “L” by the start-bit period measuring control signal S12R from the start-bit measuring unit 12.

When the sequence control unit 22 proceeds to the combination identifying process (step ST25), the sequence control unit 22 identifies the held first from third character. In the case where the above combination corresponds to “SET” or “set”, the sequence control unit 22 proceeds to a state of identifying the combination (step ST 26), and in the case where the above combination does not corresponds to any of “SET” or “set”, the sequence control unit 22 instructs the start bit measuring unit 12 to start detecting “L” of the start bit by the start bit period measuring control signal S12C and at the same time, the sequence control unit 22 returns to the confirming process of the halt instruction of detecting “SET” (step ST5). Consequently, the sequence control unit 22 becomes in the sate of detecting “L” of the start bit (step ST4), and waits for a notification of detecting “L” by the start-bit period measuring control signal S12R from the start-bit measuring unit 12.

When the sequence control unit 22 proceeds to the state of identifying the combination (step ST 26), the sequence control unit 22 identifies the held second and third characters. In the above process, in the case where the combination of “ET” or “et” does not correspond to any of hexadecimals “45” and “D4”, or “C5” and “54”, or “65” and “F4”, or “E5” and “74”, the sequence control unit 22 proceeds to a selecting process of the character set (step ST27), and in the case where the combination of “ET” or “et” corresponds to hexadecimals “45” and “D4”, or “C5” and “54”, or “65” and “F4”, or “E5” and “74”, the sequence control unit 22 instructs the start bit measuring unit 12 to start detecting “L” of the start bit by the start bit period measuring control signal S12C and at the same time, returns to the confirming process of the halt instruction of detecting “SET” (step ST5). Consequently, the sequence control unit 22 becomes in the state of detecting “L” of the start bit (step ST4), and waits for a notification of detecting “L” by the start-bit period measuring control signal S12R from the start-bit measuring unit 12.

When the sequence control unit 22 proceeds to a selecting process of the character set (step ST27), the sequence control unit 22 instructs the character set selecting unit 21 to select the character set by the character set selecting control signal S21C. The character set selecting unit 21 selects the character set values (the number of data bit, the parity form, and the number of end bit) according to the first character received from the first character identifying unit 16 by the first character identifying signal S16R, the second character received from the second character identifying unit 18 by the second character identifying signal S18R, and the third character received from the third character identifying unit 20 by the third character identifying signal S20R, referring to the table of FIG. 7, and the character set selecting unit 21 notifies the sequence control unit 22 of the character set selecting control signal S21C.

When the sequence control 22 receives the character set values from the character set selecting unit 21, the sequence control 22 processes a setting process of the communication rate and the character set to the UART. The sequence control 22 writes the held set values of the communication rate into the registers DLM, DLL of the UART 1, and furthermore writes the character set value received from the character set selecting unit 21 into the register LCR of the UART 1.

The sequence control 22 proceeds to a identifying process of the echo back request (step ST29), and in the case where the echo back request instruction is not received by the operation control signal S21C given by the CPU bus signal BUS and the interface unit 23 from the CPU, the sequence control 22 directly proceeds to a generating process of the interrupt request to the CPU (step ST31). In the case where the echo back request instruction is received thereto, the sequence control unit 22 proceeds to a writing process to the UART 1 (step ST30), and proceeds to a generating process of the interrupt request to the CPU (step ST31) after writing the held first to third characters into the register THR of the UART 1.

The sequence control unit 22 sets the held set values of the first to third characters and the communication rate held in the generating process of interrupt request to the CPU (step ST31) into a register of the IF unit 23 by the operation control signal S21C. Consequently, the sequence control unit 22 outputs an interrupt signal INT to the CPU in order to notify the CPU of completion of detecting “SET” corresponding to the instruction to start detecting “SET” from the CPU. Subsequently, the sequence control unit 22 returns to the state of halting the internal clock (step ST1) to halt the internal clock ICK from the gate unit 11 by the gate control signal S11C. The sequence control unit 22 becomes in the state of waiting the start instruction (step ST2) to wait for the instruction to start detecting “SET” from the CPU.

After receiving the interrupt signal INT, the CPU can be notified of the first to third characters, and the set values of the communication rate and the character set, being set during detecting “SET” by reading the registers of the IF unit 23 through the intermediary of the CPU bus signal BUS.

As explained before, according to the serial data receiving circuit of the first embodiment, analysis and identification of the DCE command of “SET” or “set” described in ITU-T Recommendation V.25bis as an input character string are processed. In the above operations, detecting the communication rate and identifying “S” or “s” are processed during receiving the first character, identifying “E” or “e” at the detected communication rate is processed during receiving the second character at the above detected communication rate, and identifying the communication rate and the character set is processed during receiving the third character at the above detected communication rate. Furthermore, there is a configuration that identified communication rate and character set are set into the UART 1, and echo back of the identified character of “SET” or “set” is done corresponding to a request, too. Therefore, it becomes possible that the UART 1 matches the set values of the communication rate and the character set to the communication rate and the character set requested by the DTE side of personal computers, etc., when the UART 1 receives the DCE control command of Recommendation V.25 bis.

Consequently, the CPU processes for detecting a communication rate and a character string of “SET” or “set” from alternating of the input digital signal and for calculating the character set form the detected character string of “SET” or “set” become unnecessary. Conventionally, the above processes are processed as a CPU processing to universal digital input terminals by connecting the universal digital input terminals of the CPU to the inputs of the UART 1 in parallel. Furthermore, during from when the CPU instructs to start detection of “SET” to when the CPU accepts the completion of detecting “SET” by the interrupt signal INT, in the case where the CPU receives normally a command other than “SET” or “set” of the DCE control command by reading the register RBR of the UART 1, the CPU can output the start instruction of detection “SET” through the interface unit 23. Subsequently, it becomes possible that the serial data receiving circuit halts the internal clock INT to halt the operations thereof until a start instruction of detection “SET” is provided from the CPU, and then misjudgments can be prevented from occurring and unnecessary power consumption can be restrained.

### Second Embodiment

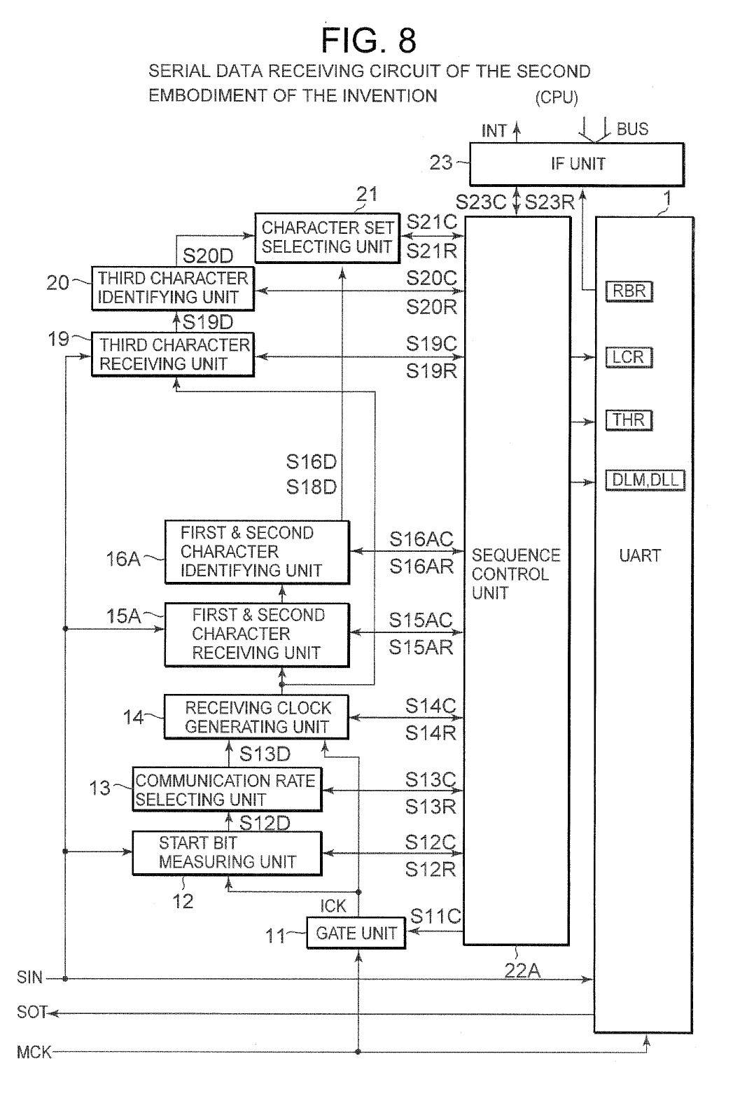

FIG. 8 is a configuration diagram of a serial data receiving circuit according to the second embodiment of the present invention, and elements identical to ones of FIG. 1 are provided with the same numerals as in FIG. 1.

In the above serial data receiving circuit, a first and second character receiving unit 15A and a first and second character identifying unit 16A are included instead of the first character receiving unit 15, the first character identifying unit 16, the second character receiving unit 17, and the second character identifying unit 18, and at the same time, a sequence control unit 22A having a slightly-different processing sequence is included instead of the sequence control unit 22.

The first and second character receiving unit 15A has the exactly same function as the first character receiving unit 15 in FIG. 1 and outputs the received character information to the first and second character identifying unit 16A as a data S15AD by receiving sequentially the first character and the second character according to the control from the sequence control unit 22A.

The first and second character identifying unit 16A outputs the identifying results of data S16D, S18D to the character set selecting unit 21 by identifying whether the first character and the second character provided from the first and second character receiving unit 15A as the data S15AD corresponds to “S”, “s”, and “E”, “e”, or “others” other than “S”, “s”, and “E”, “e”. Other configurations thereof are the same as in FIG. 1.

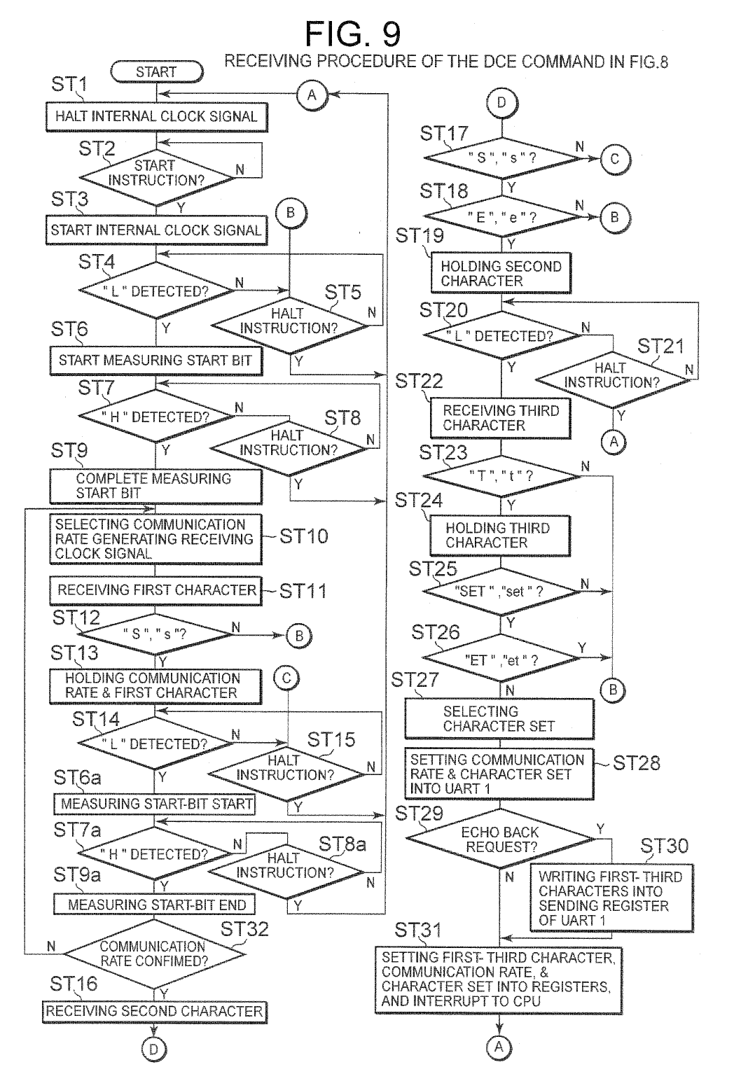

FIG. 9 is a flow chart showing a receiving procedure of the DCE control command of the serial data receiving circuit of FIG. 8, and the identical elements to ones in FIG. 2 are provided with the same numerals as in FIG. 2.

According to the receiving process of the DCE command by the above mentioned serial data receiving circuit, the communication rate is selected and the first character is received by measuring the start bit during the procedures of the steps ST 1 to ST 15, the same as in the first embodiment, using the start bit measuring unit 12, the communication rate selecting unit 13, the receiving clock generating unit 14, the first and second character receiving unit 15A, and the first and second character identifying unit 16A. Subsequently, the communication rate is measured by measuring the start bit of the second character during procedures of the steps ST 6a to ST 9a the steps ST 6 to ST9, using the first and second character receiving unit 15A again.

After the step 9a, according to confirmation process of the communication rate (step ST32), it is identified whether the communication rate is the same as in the first character or not. In the case where the communication rate is not same as in the first character, after returning to the step ST10, the communication rate is selected again to process the receiving process of the first character by generating the receiving clock signal RCK of the re-selected communication rate.

Meanwhile, in the case where it is confirmed that the communication rate is not changed in the confirmation process of the communication rate of the step ST32, the step proceeds to the step ST16 of the second character receiving process. The subsequent receiving procedures are the same as in the first embodiment.

As explained before, according to the serial data receiving circuit of the second embodiment, the first and second character receiving unit 15A of the common process for receiving the first character and the second character is included. Consequently, the configuration is slightly simplified, and at the same time, since the communication rate measuring is done in receiving process of the second character, receiving process can be continued only in the case where the communication rates of the first character and the second character are the same as each other. Therefore, the above serial data receiving circuit of the second embodiment has an advantage of being able to prevent error data-receiving caused by noise, etc., in addition to the advantage of the first embodiment.

Additionally, according to the first embodiment, during receiving process of “SET” or “set” of the DCE command described in ITU-T Recommendation V.25bis, in the case where “S” or “s” of one character or more than one are received continuously and the communication rates of the continuous characters of “S” or “s” are different, the number of continuous characters of “S” or “s” needs to be an odd number, however, according to the second embodiment, even when the communication rates of the continuous characters of “S” or “s” are different, the condition regarding the number of continuous characters of “S” or “s” can be neglected.

The present invention is not limited to the aforementioned embodiments, and applicable to various modifications. The modifications are as follows.

(a) It is possible to make a configuration that the serial input data SIN is inputted to cascade-connected multi-stage shift registers using the internal clock signal ICK more than 16 times as fast as the asynchronous communication rate from the gate unit 11, and the multi-valued output from each of the above registers is processed through a noise eliminating circuit of the existing technology in order to eliminate noise and glitch in the serial input data SIN.

(b) In the explanation of the asynchronous method, the number of the end-bit is one, however, the above bit number is not limited to one, and 1.5 bits, 2 bits, or 3 bits, etc. can be used.

(c) The receiving clock RCK having a frequency 16 times as high as the communication rate (bit rate) is taken as an example, however, the frequency is not limited to the 16 times frequency.

(d) It is explained that the first to the third character-identifying units 16, 18, 20 are configured by special hardware circuits, however, it can be configured that a software of the sequence control unit 22 identifies the characters thereof.

(e) A circuit for identifying “SET” or “set” of the DCE control command stipulated by ITU-T Recommendation V.25bis is taken as an example, however, the command character string is not limited to the example thereof.

What is claimed is:

1. A serial data receiving circuit for receiving a control command configured by a specific character string sent by a serial data of asynchronous method and identifying a communication rate and character set of said serial data being characterized by comprising;
an interface device for accepting a start instruction from the outside;
a receiving device for receiving a serial input signal inputted by asynchronous method when said start instruction is provided;
a measuring device for measuring a time length of a start bit of the first character of said serial input data;
a communication rate selecting device for selecting a communication rate corresponding to said measured time length of said start bit out of the pre-determined plural of communication rates; and
an identifying device for receiving a character string of said serial input signal according to said selected communication rate and identifying whether said received character string corresponds to said specific character string.

2. The serial data receiving circuit of any of claim 1 further comprising;
a character set selecting device for selecting said character set of asynchronous method based on said received character string when said identifying device identifies that said character string corresponds to said specific character string.

3. The serial data receiving circuit of claim 2, wherein a receiving clock signal is halted when said start instruction is not being provided, said halt instruction is provided from said outside, or receiving said character string is completed.

4. The serial data receiving circuit of any of claim 2, further comprising;
a setting device for setting said set value corresponding to said communication rate selected by said communication rate selecting device and said set value corresponding to said character set selected by said character set selecting device into an universal asynchronous transceiver.

5. The serial data receiving circuit of claim 4, wherein said character set consists of the number of data bits, the parity form, and the number of end bits of the character signal being inputted by asynchronous method.

6. The serial data receiving circuit of claim 5, wherein said control command is the DCE command stipulated by ITU-T Recommendation V.25bis and said specific character string is “SET” or “set” of three characters in ASCII.

7. A serial data receiving circuit for receiving a control command configured by a specific character string sent by a serial data of asynchronous method and identifying a communication rate and character set of said serial data being characterized by comprising;
an interface device for accepting a start instruction from the outside;
a receiving device for receiving a serial input signal inputted by asynchronous method when said start instruction is provided;
a measuring device for measuring a time length of start bit of the first and the second characters of said serial input data;
a communication rate selecting device for selecting a communication rate corresponding to said measured time length of said start bit out of the pre-determined plural of communication rates;
a confirming device for confirming whether or not the communication rate corresponding to said time length of said start bit of said first character measured by said measuring device matches to the communication rate corresponding to said time length of said start bit of said second character; and
an identifying device for receiving a character string of said serial input signal according to said selected communication rate and identifying whether said received character string corresponds to said specific character string.

8. The serial data receiving circuit of any of claim 7 further comprising;
a character set selecting device for selecting said character set of asynchronous method based on said received character string when said identifying device identifies that said character string corresponds to said specific character string.

9. The serial data receiving circuit of claim 8, wherein a receiving clock signal is halted when said start instruction is not being provided, said halt instruction is provided from said outside, or receiving said character string is completed.

10. The serial data receiving circuit of any of claim 8 further comprising;
a setting device for setting said set value corresponding to said communication rate selected by said communication rate selecting device and said set value corresponding to said character set selected by said character set selecting device into an universal asynchronous transceiver.

11. The serial data receiving circuit of claim 10, wherein said character set consists of the number of data bits, the parity form, and the number of end bits of the character signal being inputted by asynchronous method.

12. The serial data receiving circuit of claim 11, wherein said control command is the DCE command stipulated by ITU-T Recommendation V.25bis and said specific character string is “SET” or “set” of three characters in ASCII.
